(19) United States
(12) Patent Application Publication
(10) Pub. No.: US 2026/0205701 A1
(43) Pub. Date: Jul. 16, 2026

(54) CONTROL APPARATUS, IMAGE PICKUP APPARATUS, ILLUMINATION SYSTEM, CONTROL METHOD, AND STORAGE MEDIUM

(71) Applicant: CANON KABUSHIKI KAISHA, Tokyo (JP)

(72) Inventor: YUKIHIRO MATSUMOTO, Saitama (JP)

(21) Appl. No.: 19/429,111

(22) Filed: Dec. 22, 2025

(30) Foreign Application Priority Data
Jan. 14, 2025 (JP) 2025-004494

(51) Int. Cl. H04N 23/74; H04N 23/56; H04N 23/72; H04N 23/73; H04N 23/75

(52) U.S. Cl. CPC H04N 23/74; H04N 23/56; H04N 23/72; H04N 23/73; H04N 23/75

(57) ABSTRACT

A control apparatus includes one or more memories storing instructions, and one or more processors that, upon execution of the instructions, operate to acquire information about a shooting situation, perform a pre-flash of an illumination apparatus before a main flash of the illumination apparatus for a first shot in continuous shooting, determine, according to the information about the shooting situation, whether to perform the pre-flash before the main flash for a second shot or subsequent shots in the continuous shooting, and change, according to the information about the shooting situation, which of the information about the shooting situation or a result of the pre-flash is to be used to determine a light emission amount of the main flash. The information includes information about changes in at least one of a state of an object, a light metering value, a shooting scene, exposure, and a focus position during the continuous shooting.

### BACKGROUND

### Field of the Technology

The aspect of the disclosure relates to one or more embodiments of a control apparatus, an image pickup apparatus, an illumination system, a control method, and a storage medium.

### DESCRIPTION OF THE RELATED ART

Conventionally, in illumination apparatuses such as flash apparatuses (strobe apparatuses), light amount control (light regulation (or modulation or dimming) control) is known in which a pre-flash (electronic flash) is emitted with a suppressed light emission amount just before a main flash for still image recording, and a light emission amount for the main flash is determined based on factors such as a reflected light amount from an object. Japanese Patent Application Laid-Open No. 2021-113889 discloses an image pickup apparatus that controls a light emitter so as not to perform a pre-flash in a case where a light emission amount of a main flash is insufficient in the previous shooting (or imaging).

The image pickup apparatus disclosed in Japanese Patent Application Laid-Open No. 2021-113889 simply does not perform a pre-flash in a case where the pre-flash would prevent the main flash from being performed during still image recording, and the light emission amount of the main flash remains the same as that in the previous shooting. Thus, the light emission amount may not be proper, for example, during continuous shooting of a moving object.

### SUMMARY

A control apparatus according to one aspect of the disclosure includes one or more memories storing instructions, and one or more processors that, upon execution of the instructions, operate to acquire information about a shooting situation, perform a pre-flash of an illumination apparatus before a main flash of the illumination apparatus for a first shot in continuous shooting, determine, according to the information about the shooting situation, whether to perform the pre-flash before the main flash for a second shot or subsequent shots in the continuous shooting, and change, according to the information about the shooting situation, which of the information about the shooting situation or a result of the pre-flash is to be used to determine a light emission amount of the main flash. The information about the shooting situation includes information about changes in at least one of a state of an object, a light metering value, a shooting scene, exposure, and a focus position during the continuous shooting. An image pickup apparatus and an illumination system each having the above control apparatus also constitute another aspect of the disclosure. A control method corresponding to the above control apparatus and a storage medium storing a program that causes a computer to execute the above control methods also constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an image pickup system according to this embodiment.

FIG. 2 is a flowchart illustrating continuous shooting processing according to this embodiment.

FIG. 3 is a flowchart illustrating pre-flash-less determination processing according to this embodiment.

FIG. 4 is a flowchart illustrating continuous shooting processing according to a comparative example.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

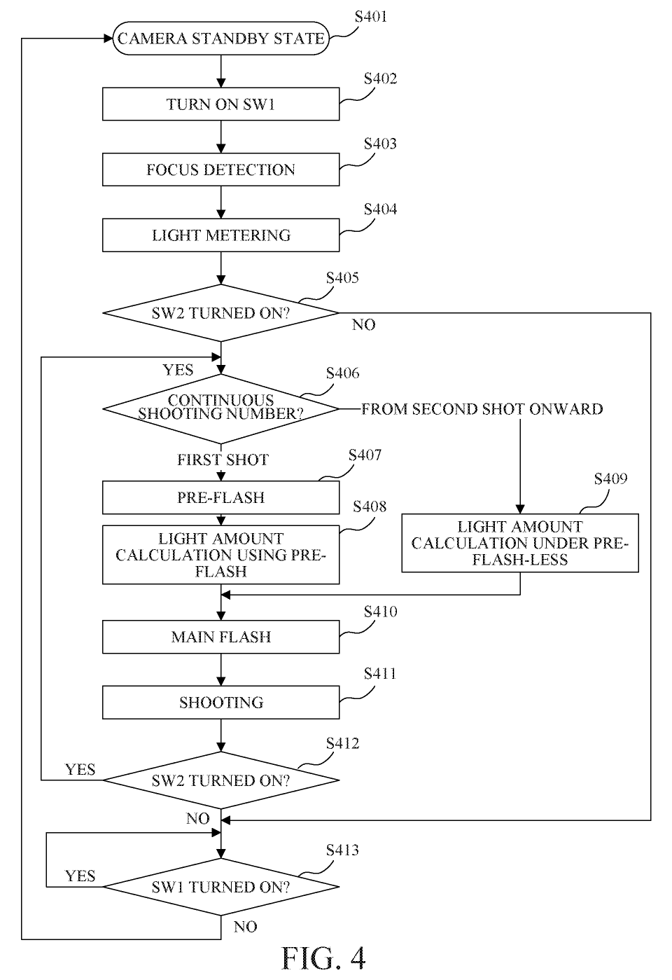

First, a comparative example relative to this embodiment will be described with reference to FIG. 4. FIG. 4 is a flowchart illustrating continuous shooting processing according to the comparative example. FIG. 4 illustrates processing in an image pickup system that does not use pre-flash during continuous shooting, in which the light emission amount of a main flash for the first shot is fixed during continuous shooting and the light emission amount of the main flash during continuous shooting is recalculated using object information between frames.

First, in step S401, a system control unit 120 in the image pickup apparatus starts live-view shooting, enters a shooting standby state, and waits for operation of SW1 of a shutter switch 131. Next, in step S402, the system control unit 120 detects that SW1 of the shutter switch 131 has been turned on. Next, in step S403, the system control unit 120 acquires the focus state of an optical image from a phase difference between two images of the object based on image data obtained from an image sensor 103 (focus detecting calculation). Next, in step S404, the system control unit 120 acquires the luminance value of the object using the image data obtained from the image sensor 103 (light metering calculation or photometric calculation).

Next, in step S405, it is determined whether SW2 of the shutter switch 131 is turned on. In a case where SW2 is turned on, the flow proceeds to step S406. In step S406, the system control unit 120 determines the number of shots in continuous shooting. In a case where this is the first shot in continuous shooting, the flow proceeds to step S407, where the control unit 120b performs a pre-flash. Next, in step S408, the system control unit 120 performs light amount calculation using the pre-flash. Next, in step S410, the control unit 120b performs a main flash for shooting using the result of the light amount calculation.

On the other hand, in a case where, in step S406, this is the second or subsequent shot in continuous shooting, the flow proceeds to step S409. In step S409, the system control unit 120 performs a light amount calculation to determine the light amount of the main flash using the light emission result from the previous shooting, etc. Next, in step S410, the control unit 120b uses the result of the light amount calculation to perform a main flash for shooting.

In step S411, the system control unit 120 controls shooting while performing the main flash using the result of the light amount calculation calculated in either step S408 or S409.

After shooting, in step S412, the system control unit 120 determines whether SW2 of the shutter switch 131 is turned on. In a case where SW2 is turned on, the flow returns to step S406, where the system control unit 120 continues shooting. On the other hand, in a case where SW2 is turned off, the flow proceeds to step S413. In step S413, the system control unit 120 determines whether SW1 is turned off. In a case where SW1 is turned on, the flow repeats the determination of step S413. On the other hand, in a case where SW1 is turned off, the flow returns to step S401, where the system waits for the next shot.

### BASIC CONFIGURATION OF IMAGE PICKUP SYSTEM

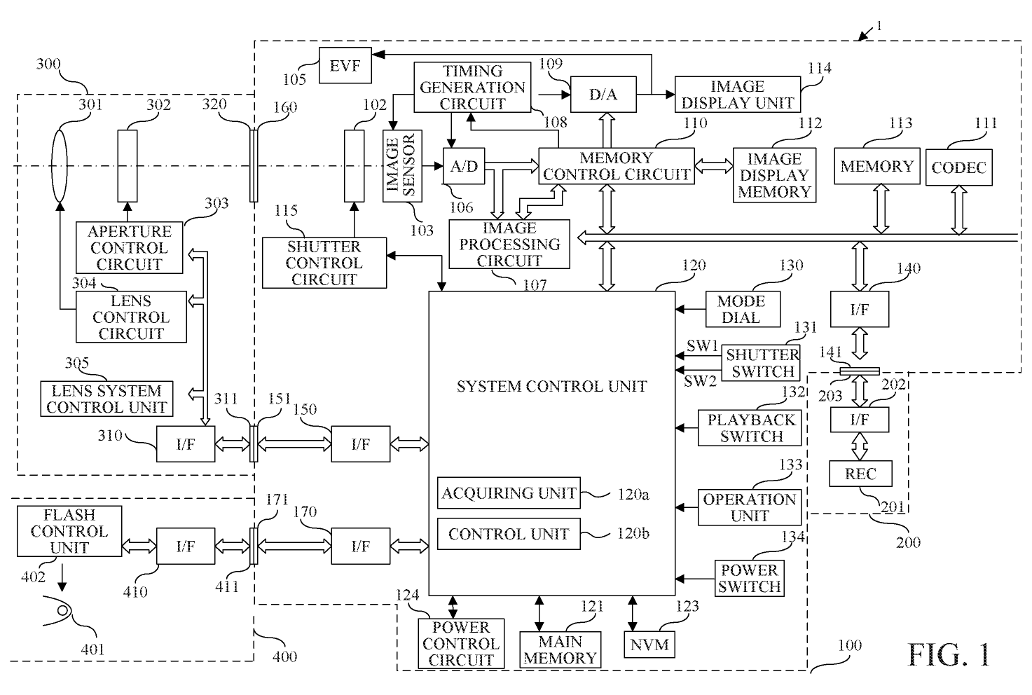

Next, with reference to FIG. 1, an image pickup system (digital camera system, illumination system) 1 according to an embodiment of the disclosure will be described. FIG. 1 is a block diagram of the image pickup system 1. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

The image pickup system 1 is a lens interchangeable type camera system including a camera body (image pickup apparatus) 100, an external recording medium 200, a lens unit (lens apparatus) 300, and a light emitting unit (illumination apparatus) 400. In this embodiment, each of the lens unit 300 and the light emitting unit 400 is attachable to and detachable from the camera body 100, but this embodiment is not limited to this example. At least one of the lens unit 300 and the light emitting unit 400 may be integrated with the camera body 100.

A shutter 102 is a light shielding member that opens and shields the optical path between the lens unit 300 and the image sensor 103 using a front curtain and a rear curtain (not illustrated). Alternatively, the shutter 102 may have a function of resetting or reading out image data captured by the image sensor 103 through electrical control.

The image sensor 103 is a charge-accumulation type image sensor such as a CMOS sensor, and performs photoelectric conversion (captures an image) of an object image (optical image) formed via the lens unit 300 to generate and output analog image data.

An electronic viewfinder (EVF) 105 is an electronic viewfinder that uses a thin film transistor liquid crystal display (TFT LCD) or an organic electroluminescence element (organic EL element) to allow the user to check the object image. An A/D converter 106 converts analog image data output from the image sensor 103 into digital image data. An image processing circuit 107 performs various processing, such as white balance adjustment and gradation processing, on the digital image data output from the A/D converter 106.

A timing generation circuit 108 generates a signal (a control signal such as a clock signal) for operating the image sensor 103, the A/D converter 106, and a D/A converter 109 (described later). The timing generation circuit 108 can also control the accumulated charges in the image sensor 103 by controlling the reset timing of the accumulated charges in the image sensor 103. The timing generation circuit 108 is controlled by the system control unit 120, which will be described later.

A memory control circuit 110 controls the A/D converter 106, the image processing circuit 107, the D/A converter 109, and a compression/decompression (expansion) circuit (CODEC) 111, and writes the acquired image data to an image display memory 112 or a memory (image recorder) 113. An image display unit 114 is a display unit such as a TFT LCD or organic EL element, similarly to the electronic viewfinder 105 described above. The digital image data for display written into the image display memory 112 is converted by the D/A converter 109 into analog image data for display, and is then displayed on the electronic viewfinder 105 or image display unit 114.

The memory 113 is a recorder for storing image data acquired by capturing (an image of) an object, and has sufficient storage capacity to store a predetermined number of still image data and moving image data. The memory 113 can be used as a work area for the system control unit 120, which will be described later.

The CODEC 111 reads image data stored in the memory 113 and compresses and decompresses the image data according to predetermined image compression and decompression methods to suit a variety of applications. The shutter control circuit 115 is a shutter control unit that controls the operation of the shutter 102 based on the light metering result of the object calculated by the system control unit 120. The shutter 102 can be controlled in conjunction with the control of an aperture stop 302, which will be described later.

The system control unit 120 is a control apparatus that comprehensively controls the operation of the image pickup system 1, and includes an acquiring unit 120a and a control unit 120b. The acquiring unit 120a and the control unit 120b achieve at least a part of the functions of the system control unit 120. The acquiring unit 120a acquires information on the shooting condition (described later) (for example, information acquired using image data from the image sensor 103). The control unit 120b controls the light emitting unit 400. As described above, the system control unit 120 functions as a detector configured to detect the face of an object and distinguishes between objects (people, animals, etc.) based on image data captured by the image sensor 103. The system control unit 120 also functions as an exposure control unit configured to control exposure, a light amount calculator configured to calculate the light emission amount for shooting using the light emitting unit 400, a scene discriminator configured to distinguish between scenes based on the state and exposure of the object, and a focus control unit based on a focus detection result. Each piece of information is acquired by the acquiring unit 120a.

More specifically, the system control unit 120 detects the focus state of the optical image from a phase difference between two images of the object based on the captured image data, and controls a lens position (focus control) based on the results of this focus detection. As another focus control method, the system control unit 120 uses image data captured by the image sensor 103 to control the lens position (focus control) based on contrast information of the acquired image data while shifting the position of the focus lens. The system control unit 120 then acquires this information via the acquiring unit 120a.

The system control unit 120 can perform flicker detection using image data captured by the image sensor 103, determine whether flicker is present in the shooting environment, and detect the flicker cycle. This information is acquired by the acquiring unit 120a. The system control unit 120 can also perform light metering calculation to calculate the luminance value of an object using image data captured by the image sensor 103, and this information is acquired by the acquiring unit 120a. The system control unit 120 then adjusts exposure parameters such as an aperture value (F-number), a shutter speed, and shooting sensitivity (ISO sensitivity or speed) as exposure control when capturing an image of the object and acquiring image data.

In a case where the object is dark or in a case where the camera setting involves shooting using the light emitting unit 400, the system control unit 120 performs a pre-flash to cause a flashlight emitter 401 to emit light just before shooting in order to perform a light amount calculation to calculate a light emission amount during shooting. The system control unit 120 then performs a light amount calculation to determine the light emission amount for flashlight (main flash) during shooting using the light amount of a pre-flash and two images with no pre-flash. The aperture value is a parameter regarding the opening rate of the aperture stop 302. The shutter speed is a parameter regarding the charge accumulation time in the image sensor 103. The shooting sensitivity is a parameter regarding an analog gain and a digital gain.

The charge accumulation time can be controlled by controlling the shutter 102 or image sensor 103 described above. In particular, for live-view and a moving image, the charge accumulation time is controlled by controlling the image sensor 103.

The system control unit 120 also communicates with the light emitting unit 400 based on the results of the light metering calculation, camera setting, or the state of the light emitting unit 400, which will be described below. The system control unit 120 then controls the light emission amount and light emission timing of the flashlight emitter 401 via a flash control unit 402. The system control unit 120 can set the start and end of moving image recording based on user settings made through operation of an operation unit 133. The system control unit 120 can switch a shooting range of the image sensor 103 based on user operation of the operation unit 133, allowing it to capture an image using the entire pixel output of the image sensor 103 or a cut portion of that pixel output.

Thus, the system control unit 120 can change the proper exposure for the luminance value, control the light emitting unit 400, and change the shooting range of the image sensor 103 based on various information such as the luminance of the object, exposure control, and settings. The control unit 120b also determines whether to perform a pre-flash before a main flash for continuous shooting, according to information about a shooting condition.

A main memory 121 stores data on the operation of the image pickup system 1, such as information (a program diagram using table data) on exposure (proper exposure) for a luminance value, constants for operations executed by the image pickup system 1, a variety of exposure conditions, and calculation equations. A nonvolatile memory 123 is a memory such as an EEPROM, which can be electrically erased and stored, such as a flash memory.

A mode dial 130, the shutter switch 131, a playback switch 132, the operation unit 133, and a power switch 134 are operation units for inputting a variety of operation instructions to the system control unit 120. These operation units may include buttons, switches, dials, touch panels, line-of-sight detection devices, voice recognition devices, or a combination of them.

The mode dial 130 is an operation member used to set an arbitrary shooting mode from among a plurality of shooting modes settable by the camera body 100. The image pickup system 1 can be set to a normal still image mode for shooting to acquire a still image, or a moving image mode for shooting to record a moving image. The system control unit 120 in the image pickup system 1 has a variety of modes for both still and moving image shooting, allowing for automatic or manual settings of exposure parameters, such as automatic, program, aperture-priority, shutter-speed-priority, and manual parameters. The system control unit 120 can set whether to use flashlight emission during still image recording.

For both still and moving image recording, a live-view display function can be implemented by displaying an image (live-view image) on the electronic viewfinder 105 or image display unit 114 to confirm an object. The live-view display function sequentially displays a plurality of image data acquired by continuously accumulating electric charges (capturing images) using the image sensor 103.

The shutter switch 131 is an operation member used by the user to instruct the start of a shooting preparation operation and a shooting operation for an object for still or moving image recording. The first stroke (e.g., half-pressing) of the shutter switch 131 turns on SW1. Turning on SW1 starts the shooting preparation operation, and the system control unit 120 performs the focus control, exposure calculation, etc.

The second stroke (e.g., full pressing) of the shutter switch 131 turns on SW2. Turning on SW2 starts the shooting operation, and the system control unit 120 starts exposure processing and recording processing regarding charge accumulation (shooting) using the image sensor 103.

In the exposure processing, according to an instruction from the system control unit 120, a signal read from the image sensor 103 is written as image data to the memory 113 via the A/D converter 106 and the memory control circuit 110. Then, according to the instruction from the system control unit 120, development processing is performed on the image data based on a variety of calculations in the image processing circuit 107 and the memory control circuit 110, and the developed image data is written to memory 113.

In the recording processing, the developed image data read from the memory 113 is compressed by the CODEC 111 in accordance with the instruction from the system control unit 120. Thereafter, in accordance with the instruction from the system control unit 120, the compressed image data is written to a recorder 201 of the external recording medium 200 via a first camera interface (I/F) 140, a first camera connector 141, a media connector 203, and a media I/F 202.

The playback switch 132 is an operation member for instructing the start of playback processing in which acquired image data is read from the memory 113 or the external recording medium 200 and displayed on the image display unit 114. As discussed above, the operation unit 133 is an operation member used to start and stop moving image recording, set a variety of settings regarding to menu display and shooting, and set a variety of settings regarding playback.

The user can set a variety of settings, including flash shooting in which the flashlight emitter 401 of the light emitting unit 400 emits flashlight, as well as the shutter time, aperture value, ISO sensitivity, and whether or not there are flickers during shooting. In flash shooting settings, a "pre-flash-less" setting can be made, which does not use a pre-flash during continuous shooting. In flash shooting, a pre-flash is a flashlight emission that occurs before the main flash before shooting in order to calculate the flashlight emission amount during shooting. The light amount control refers to determining the light emission amount of the main flash for shooting from the reflected light amount and controlling the light emission of the flashlight emitter 401. In a case where the pre-flash-less setting during continuous shooting described above is set, the system control unit 120 does not use a pre-flash, but instead determines the light emission amount of the main flash during continuous shooting (the main flashlight emission amount) using information about the shooting situation, such as an object detection result.

The power switch 134 is an operation member used to turn on and off the power supply from a power supply unit (battery) (not illustrated) to each component in the image pickup system 1. Operating the power switch 134 can switch on and off the power supply not only to the camera body 100, but also to a variety of accessory apparatuses connected to the camera body 100, such as the lens unit 300 and external recording medium 200.

The power control circuit 124 is a power control unit that includes a battery detection circuit, a DC-DC converter, and a switch circuit used to switch between power supply blocks. Based on the instruction from the system control unit 120 according to the operation of the power switch 134, the power control circuit 124 detects whether a battery is installed, the battery type, and the remaining battery level, and supplies the required voltage for the required period to each component in the image pickup system 1.

A second camera I/F 150 is provided in a camera mount unit 160 and serves as an interface for connecting the camera body 100 and the lens unit 300. The second camera connector 151 is a connector that electrically connects the camera body 100 and the lens unit 300 via a lens connector 311 and a lens I/F 310.

A third camera I/F 170 is an interface for connecting the camera body 100 and the light emitting unit 400. A third camera connector 171 is a connector that electrically connects the camera body 100 and the light emitting unit 400 via a light emitting unit connector 411 and the flash I/F 410.

The second camera connector 151 and the third camera connector 171 can transmit a control signal, a status signal, a data signal, etc., and supply currents of various voltages between the camera body 100 and the lens unit 300 or the light emitting unit 400. The second camera connector 151 and the third camera connector 171 may also be configured to transmit not only electrical communications, but also optical communications or audio communications.

The external recording medium 200 is an external recording device such as a memory card or a hard disk drive. The external recording medium 200 includes the recorder 201 that includes a semiconductor memory, a magnetic disk, or the like, a media I/F 202 for the camera body 100, and a media connector 203 for connecting to the camera body 100.

The lens unit 300 is an optical apparatus that can be attached to and detached from the camera body 100. A lens mount unit 320 is engaged with the camera mount unit 160 and is a connector for mechanically attaching the lens unit 300 to the camera body 100. Inside the lens mount unit 320 is a lens connector 311 that electrically connects the lens unit 300 and the camera body 100.

The lens connector 311 can transmit a control signal, a status signal, a data signal, and the like between the lens unit 300 and the camera body 100, receive and supply currents of various voltages. The lens connector 311 may also be configured to transmit not only electrical communications, but also optical communications or audio communications.

An imaging lens 301 is an optical component (imaging optical system) that includes a focus lens, a zoom lens, and a shift lens. The aperture stop 302 is a light-intensity adjusting component that adjusts a light amount from an object that passes through the imaging lens 301 and enters the image sensor 103. The aperture control circuit 303 controls the aperture size of the aperture stop 302 based on an instruction from the system control unit 120.

The system control unit 120 instructs the aperture control circuit 303 to change the aperture diameter of the aperture stop 302 so that it corresponds to the target aperture value. The aperture diameter of the aperture stop 302 being changed is detected sequentially through mutual communications between the lens unit 300 and the camera body 100. The system control unit 120 stops changing the aperture diameter of the aperture stop 302 in a case where the aperture diameter of the aperture stop 302 reaches the aperture diameter corresponding to the target aperture value.

The lens control circuit 304 controls the operation (driving) of the imaging lens 301. The lens control circuit 304 can also detect the lens position (focus position) of the focus lens. Information on the detected lens position is transmitted to the camera body 100.

A lens system control unit 305 provides overall control of the lens unit 300. The lens system control unit 305 contains a CPU, volatile memory, and nonvolatile memory (not illustrated). The volatile memory stores operational constants, variables, programs, etc. The nonvolatile memory stores identification (ID) information such as a unique number for the lens unit 300, management information, and functional information such as the maximum aperture value, minimum aperture value, and focal length.

The light emitting unit 400 is an illumination apparatus that is attachable to and detachable from the camera body 100. The light emitting unit connector 411 can transmit a control signal, a status signal, a data signal, etc. between the light emitting unit 400 and the camera body 100, as well as receiving and supplying current at various voltages. The light emitting unit connector 411 may be configured to transmit not only electrical communications, but also optical communications or audio communications. The flash control unit 402 controls the light emission amount of the flashlight emitter 401 and light emission in accordance with various settings of the light emitting unit 400.

A variety of settings of the light emitting unit 400 can be made via communication from the camera body 100, or by operation using a light-emission-apparatus operation unit (not illustrated). The light emitting unit 400 also communicates its status to the camera body 100, such as its light emission preparation state (charging state) and the orientation of the flashlight emitter 401, and the system control unit 120 uses this status information of the light emitting unit 400 for the light amount calculation.

The flash control unit 402 includes a CPU, volatile memory, and nonvolatile memory (not illustrated). The volatile memory stores constants, variables, programs, and other operational data. The nonvolatile memory stores identification information for the light emitting unit 400, such as a unique number, management information, and functional information such as the upper and lower limit light emission amounts. This concludes the basic configuration of the image pickup system 1.

### OPERATION OF IMAGE PICKUP SYSTEM

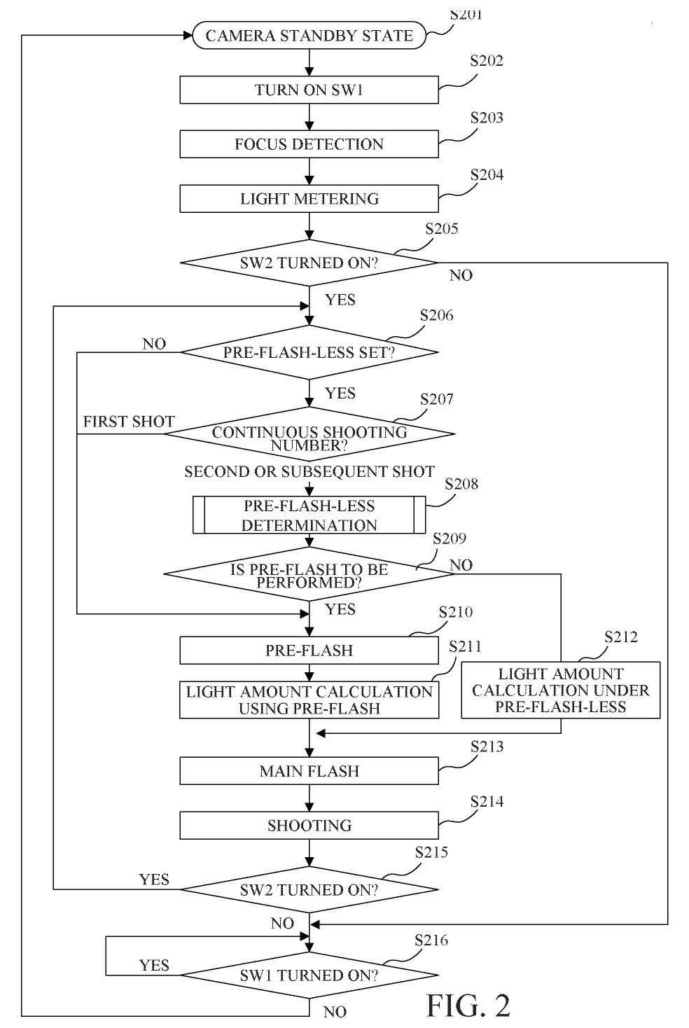

Next, with reference to FIG. 2, a control method (continuous shooting processing) for the image pickup system 1 according to this embodiment will be described. FIG. 2 is a flowchart illustrating a control method for the image pickup system 1 according to this embodiment.

First, in step S201, the system control unit 120 starts live-view shooting and enters a shooting standby state, waiting for SW1 of the shutter switch 131 to be operated. Next, in step S202, the system control unit 120 detects that SW1 of the shutter switch 131 has been turned on. Next, in step S203, the system control unit 120 calculates the focus state of the optical image from the phase difference between two images of the object based on image data obtained from the image sensor 103 by shooting, and the acquiring unit 120a acquires the result (focus detecting calculation). Next, in step S204, the system control unit 120 calculates the luminance value of the object using the image data obtained from the image sensor 103, and the acquiring unit 120a acquires the result (light metering calculation).

Next, in step S205, it is determined whether SW2 of the shutter switch 131 is turned on. In a case where SW2 is turned on, the flow proceeds to step S206. In step S206, the system control unit 120 determines whether it is set so that a pre-flash is not performed during continuous shooting (whether the pre-flash-less setting is enabled or not). In a case where it is set so that a pre-flash is not performed, the flow proceeds to step S207.

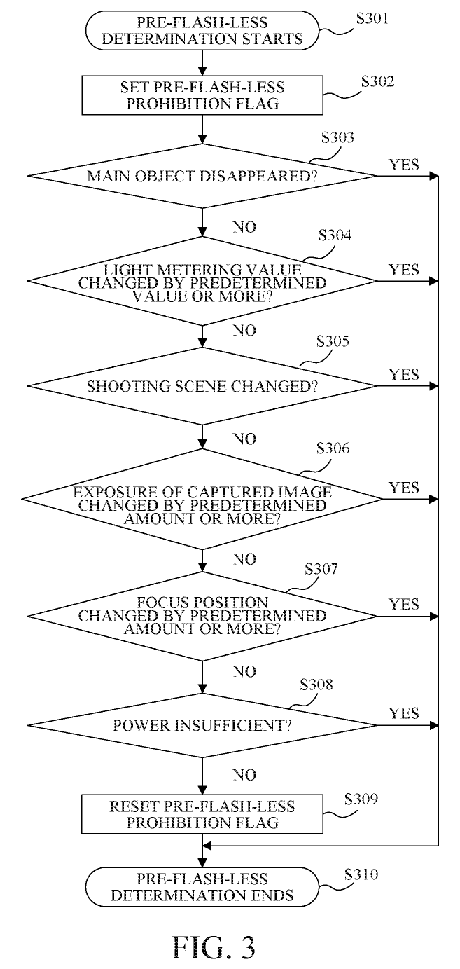

In step S207, the system control unit 120 determines the number of shots in continuous shooting. In a case where this is the first shot (first time) of continuous shooting, the flow proceeds to step S210, where the control unit 120b performs a pre-flash. On the other hand, in a case where this is the second or subsequent shot (second or subsequent time) of continuous shooting, the flow proceeds to step S208, where the system control unit 120 performs processing to determine whether the pre-flash set in step S206 should be performed (pre-flash-less determination processing). Details of the pre-flash-less determination processing will be described later with reference to FIG. 3.

Next, in step S209, the system control unit 120 determines whether to perform a pre-flash, based on the result of the pre-flash-less determination in step S208. In a case where a pre-flash is to be performed, the flow proceeds to step S210. In step S210, the control unit 120b performs a pre-flash. Next, in step S211, the system control unit 120 uses the result of the pre-flash to perform a light amount calculation to determine the light emission amount of the main flash. Next, in step S213, the control unit 120b performs a main flash for shooting, using the result of the light amount calculation. On the other hand, in a case where it is determined in step S209 that a pre-flash is not to be performed, the flow proceeds to step S212. In step S212, the acquiring unit 120a acquires information about the shooting situation, such as the object detection result, and using that result, the system control unit 120 performs a light amount calculation to determine the light emission amount of the main flash.

In step S214, the system control unit 120 performs a main flash while performing shooting, using the result of the dimming calculated in either step S211 or S212.

After shooting, in step S215, the system control unit 120 determines whether SW2 of the shutter switch 131 is turned on. In a case where SW2 is turned on, the flow returns to step S206, and the system control unit 120 continues shooting. On the other hand, in a case where SW2 is turned off, the flow proceeds to step S216. In step S216, the system control unit 120 determines whether SW1 has been turned off. In a case where SW1 is turned on, the flow repeats the determination of step S216. On the other hand, in a case where SW1 is turned off, the flow returns to step S201, and the system waits for the next shooting.

Next, the pre-flash-less determination in step S208 in FIG. 2 will be described with reference to FIG. 3. FIG. 3 is a flowchart illustrating the pre-flash-less determination processing.

First, in step S301, the system control unit 120 starts the pre-flash-less determination processing. Next, in step S302, the system control unit 120 sets a pre-flash-less prohibition flag (make a setting to perform a pre-flash) and checks for changes in the status of the object (shooting status).

Next, in step S303, the system control unit 120 determines the status of the main object from the status of the main object, such as whether the main object acquired by the acquiring unit 120a has disappeared. In a case where it is determined that the status of the main object has not changed (for example, the main object continues to be detected), it is determined that the pre-flash calculation was successful, and the flow proceeds to step S304. On the other hand, in a case where the main object has disappeared, it is determined that the status of the main object has changed, and the flow proceeds to step S310, where the pre-flash-less prohibition flag is set (setting to perform a pre-flash), and this flow ends.

The determination condition in step S303 is not limited to the case where the system control unit 120 determines that a detection result (object) that the acquiring unit 120a had been able to detect until now has disappeared. For example, this may be the case where a predetermined parameter, such as the reliability of the detection result, has changed, or where the detection result has changed, such as from a person to an animal. Alternatively, this may include, for example, a case where the detection result is the same object (for example, still a person) but the object has been transferred to another object, or a case where the position of the object has changed by a predetermined amount or more based on information such as a defocus map.

In step S304, the system control unit 120 determines whether the light metering value acquired by the acquiring unit 120a has changed by a predetermined amount or more. In a case where the change in the measurement value is less than the predetermined amount, it is determined that the pre-flash calculation was successful, and the flow proceeds to step S305. On the other hand, in a case where it is determined that the light metering value has changed by the predetermined amount or more, the flow proceeds to step S310, where the pre-flash-less prohibition flag is set (a state in which a pre-flash is set to be performed), and this flow ends.

In step S305, the system control unit 120 determines whether the shooting scene has changed. Whether the shooting scene has changed can be determined comprehensively from information detectable by the image pickup system 1, such as the light metering value, luminance distribution, or orientation of the image pickup system 1 acquired by the acquiring unit 120a. For example, in a case where panning (panning information) of the image pickup system 1 is detected from the output of a gyro sensor (not illustrated), or in a case where the luminance distribution changes in addition to the panning information, it can be determined that the shooting scene has changed.

In a case where it is determined that the shooting scene has not changed, it is determined that the pre-flash calculation was performed correctly, and the flow proceeds to step S306. On the other hand, in a case where it is determined that the shooting scene has changed, the flow proceeds to step S310, where the pre-flash-less prohibition flag is set (a state in which a pre-flash is set to be performed), and this flow ends.

In step S306, the system control unit 120 uses an image actually captured with a flash (captured image) to determine whether the exposure of the image has changed by a predetermined amount or more. In a case where it is determined that a change amount in image exposure is less than the predetermined amount, it is determined that the pre-flash calculation was performed correctly, and the flow proceeds to step S307. On the other hand, in a case where it is determined that the image exposure has changed by a predetermined amount or more, the flow proceeds to step S310, where the pre-flash-less prohibition flag is set (pre-flash execution is enabled), and the flow ends. In determining the image exposure, the captured image may be evaluated in real time without being saved to the memory 113, as with light metering in live-view. Alternatively, the captured image may be temporarily saved in the memory 113 and then evaluated before the next shooting.

In step S307, the system control unit 120 determines whether the focus position of the focus lens acquired by the acquiring unit 120a has changed by a predetermined amount or more. In a case where the change in focus position is less than the predetermined amount, the pre-flash calculation result is determined to be successful, and the flow proceeds to step S308. On the other hand, in a case where it is determined that the focus position has changed by the predetermined amount or more, it is highly likely that the object has moved, and the pre-flash prediction is likely to fail. Therefore, the flow proceeds to step S310, where the pre-flash-less prohibition flag is set (pre-flash execution is enabled), and the flow ends.

In step S308, the system control unit 120 determines the charge state (power state) of the light emitting unit 400. In a case where it is determined that the charge state is sufficient for light emission, the flow proceeds to step S309. In step S309, the system control unit 120 resets the pre-flash-less prohibition flag. That is, the system control unit 120 permits pre-flash-less and performs continuous shooting without performing a pre-flash during continuous shooting. On the other hand, in a case where it is determined that the charge state is not sufficient for light emission, the flow proceeds to step S310, where the pre-flash less prohibition flag is set (a state in which a pre-flash is set to be performed), and this flow ends. The system control unit 120 checks the pre-flash-less prohibition flag in step S208 of FIG. 2 and switches between performing a pre-flash and not performing a pre-flash.

As described above, in this embodiment, the system control unit 120 (control unit 120b) performs a pre-flash before capturing the first frame (first time) during continuous shooting, thereby determining the light emission amount of the main flash for capturing the first frame. The system control unit 120 also determines whether to perform a pre-flash before shooting of the second or subsequent frames (second time) during continuous shooting, based on information about the shooting condition before shooting of the second or subsequent frames during continuous shooting. The information about the shooting condition is information about changes in at least one of the state of the object, light metering value, shooting scene, exposure, and focus position.

For example, the system control unit 120 performs a pre-flash in a case where it determines that the state of the object has changed during continuous shooting. Alternatively, for example, the system control unit 120 performs a pre-flash in a case where it determines that the light metering value has changed during continuous shooting. Alternatively, for example, the system control unit 120 performs a pre-flash in a case where it determines that the shooting scene has changed during continuous shooting. For example, the system control unit 120 performs a pre-flash in a case where it determines that the exposure has changed during continuous shooting. For example, the system control unit 120 performs a pre-flash in a case where it determines that the focus position has changed during continuous shooting. For example, the system control unit 120 may perform a pre-flash in a case where it determines that the power (charge amount) of the light emitting unit 400 is insufficient during continuous shooting.

The system control unit 120 may determine the light emission amount of the main flash using information about the shooting situation or the result of the pre-flash according to information about the shooting situation.

The information about the shooting situation may be information acquired using image data from the image sensor 103 (such as information about the object acquired from the image data).

In the image pickup system 1 according to this embodiment, the light emitting unit 400 is attached to the camera body 100, but the light emitting unit 400 may be integrated with the camera body 100. In the image pickup system 1 according to this embodiment, the lens unit 300 is attached to the camera body 100, but this embodiment is not limited to this example.

This embodiment has discussed a digital camera as an example, but is not limited to this example. This embodiment is applicable to image pickup apparatuses other than digital cameras, such as portable devices including digital video cameras or smartphones, wearable devices, on-board (in-vehicle) cameras, and surveillance cameras.

In this embodiment, the components of the image pickup system 1, such as the image processing circuit 107, memory control circuit 110, and system control unit 120, operate in conjunction with each other to control the operation of the image pickup system 1, but this embodiment is not limited to this example. For example, a (computer) program according to the flowchart of FIG. 2 described above may be stored in advance in the main memory 121. The program may then be executed by the system control unit 120 including the microcomputer, thereby controlling the operation of the image pickup system 1.

As long as the program functions, any form of program is acceptable, including object code, a program executed by an interpreter, or script data supplied to an OS. The recording medium for supplying the program may be, for example, a hard disk drive, a magnetic recording medium such as magnetic tape, or an optical/magneto-optical recording medium.

Each embodiment relates to a system that calculates the light emission amount of the main flash without performing a pre-flash during continuous shooting. In a case where it is determined that a proper light emission amount can no longer be calculated, a pre-flash is performed to recalculate the proper light emission amount, and continuous shooting is continued. Thereby, it is possible to increase the frame rate and the number of shots of continuous shooting using a flash, i.e., a proper light emission amount of a main flash. Therefore, each embodiment can provide a control apparatus, an image pickup apparatus, an illumination system, a control method, and a storage medium, each of which can set a proper light emission amount for continuous shooting.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004494, filed on January 14, 2025, which is hereby incorporated by reference herein in its entirety.

What is claimed is:

1. A control apparatus comprising:
one or more memories storing instructions; and
one or more processors that, upon execution of the instructions, operate to:
acquire information about a shooting situation,
perform a pre-flash of an illumination apparatus before a main flash of the illumination apparatus for a first shot in continuous shooting,
determine, according to the information about the shooting situation, whether to perform the pre-flash before the main flash for a second shot or subsequent shots in the continuous shooting, and
change, according to the information about the shooting situation, which of the information about the shooting situation or a result of the pre-flash is to be used to determine a light emission amount of the main flash,
wherein the information about the shooting situation includes information about changes in at least one of a state of an object, a light metering value, a shooting scene, exposure, and a focus position during the continuous shooting.

2. The control apparatus according to claim 1, wherein the one or more processors operate to determine, according to the information about the shooting situation, whether to perform the pre-flash before the second shot or the subsequent shots in the continuous shooting.

3. The control apparatus according to claim 1, wherein the one or more processors operate to perform the pre-flash before the first shot in the continuous shooting, thereby determining the light emission amount of the main flash during shooting for the first shot.

4. The control apparatus according to claim 1, wherein the information about the shooting situation includes information acquired using image data from an image sensor.

5. The control apparatus according to claim 1, wherein the one or more processors operate to perform the pre-flash when determining that the state of the object has changed during the continuous shooting.

6. The control apparatus according to claim 1, wherein the one or more processors operate to perform the pre-flash when determining that a light metering value has changed during the continuous shooting.

7. The control apparatus according to claim 1, wherein the one or more processors operate to perform the pre-flash when determining that the shooting scene has changed during the continuous shooting.

8. The control apparatus according to claim 1, wherein the one or more processors operate to perform the pre-flash when determining that exposure has changed during the continuous shooting.

9. The control apparatus according to claim 1, wherein the one or more processors operate to perform the pre-flash when determining that a focus position has changed during the continuous shooting.

10. The control apparatus according to claim 1, wherein the one or more processors operate to perform the pre-flash when determining that power of the illumination apparatus is insufficient for the continuous shooting.

11. An image pickup apparatus comprising:
a control apparatus according to claim 1; and
an image sensor.

12. An illumination system comprising:
an image pickup apparatus according to claim 11; and
the illumination apparatus.

13. A control method comprising:
acquiring information about a shooting situation;
performing a pre-flash of an illumination apparatus before a main flash of the illumination apparatus for a first shot in continuous shooting;
determining, according to the information about the shooting situation, whether to perform the pre-flash before the main flash for a second shot or subsequent shots in the continuous shooting; and
changing, according to the information about the shooting situation, which of the information about the shooting situation or a result of the pre-flash is to be used to determine a light emission amount of the main flash,
wherein the information about the shooting situation includes information about changes in at least one of a state of an object, a light metering value, a shooting scene, exposure, and a focus position during the continuous shooting.

14. A non-transitory computer-readable storage medium storing a program that causes a computer to execute the control method according to claim 13.
